(19) United States
(12) Patent Application Publication
(10) Pub. No.: US 2007/0282635 A1
(43) Pub. Date: Dec. 6, 2007

(54) System For Automatically Generating A Medical Data Message

(76) Inventors: Yannick Kereun, Aix En Provence (FR); Laurent Prax, Mimet (FR)

Correspondence Address: YOUNG & THOMPSON, 745 SOUTH 23RD STREET, 2ND FLOOR, ARLINGTON, VA, 22202, US

(21) Appl. No.: 11/578,958

(22) PCT Filed: Apr. 20, 2005
(86) PCT No.: PCT/FR05/00983

§ 371 Date: Mar. 20, 2007

(30) Foreign Application Priority Data
Apr. 23, 2004 (FR) 04 04351

(51) Int. Cl. G06F 19/00

(52) U.S. Cl. 705/3

(57) ABSTRACT

A system (10) for automatically generating a patient-related medical data message via a generating station (12) made available to a medical practitioner and connected to a data server (15) via a data transmission network (14). The system includes elements (16, 18, 20, 22) that the medical practitioner can actuate to trigger message generation, practitioner ID data input elements (32, 22), patient ID data input elements (34, 22), patient-related medical data input elements (40, 22), elements (44) for combining the various data to form a message in a predetermined network transmission format, and elements (54) for transmitting the message to the server over the network.

The present invention concerns a system for automatically generating a medical data message relating to a patient, by means of a generating station made available to a medical operator and connected to a data server via a data transmission network.

The medical data relating to a patient tend nowadays to be centralised by means of information technology at at least one central medical data server in order to facilitate the management of the data by the practitioner or practitioners in the medical field, general practitioners, specialists or others, whom the patient is led to consult throughout his life.

Conventionally, a practitioner in the medical field has at his disposal data processing means, for example an office computer, at his place of work, and with which he is able to manage medical data concerning the patient in IT format, produced as a result of a medical procedure, for example a consultation, an X-ray, a prescription, etc . . .

However, in general, one can observe no homogeneity of the IT tools used by practitioners in the medical field for managing and/or storing the data, or exchanging it with the medical data server.

In particular, there is no single type of data file format used, so that some of the practitioners cannot be connected to the central medical data server for the exchange of data, since they do not use the correct file format for this type of exchange.

Moreover, even when a practitioner adopts the correct type of file format for the exchange, problems occur in the identification of the data exchanged with the server in relation to the patient and the practitioner with which they are associated. For example, when an X-ray is converted to the correct IT format and is transmitted as it is to the server, it does not comprise data permitting automatic identification, by the server for example, of the practitioner and the patient with which it is associated, so that additional identification processing is necessary.

The aim of the present invention is to solve the above-mentioned problems by proposing a generating system adapted to automatically generate a medical data message in an IT format compatible with the exchange of data with at least one medical data server and comprising data identifying the practitioner and the patient with which the medical data is associated.

To this end, the subject of the present invention is a system for automatically generating a medical data message relating to a patient, by means of a generating station made available to a medical operator and connected to a data server via a data transmission network, characterized in that it comprises:

means that can be activated by an operator in the medical field to trigger the generation of the message;

means for acquisition of data identifying a practitioner;

means for acquisition of data identifying the patient;

means for acquisition of medical data relating to the patient;

combination means for combining the various data to form a message according to a predetermined format for transmission on the network; and

output means for outputting the message on the network to the destination of the server.

According to another characteristic, the combination means are adapted to form a message in the form of a single file comprising the whole of said data.

According to another characteristic:

the predetermined format for transmission of the message is also a predetermined print format;

the predetermined print format is a “PostScript” format;

the print format is a “Portable Document Format”.

According to another characteristic, the system comprises conversion means adapted to convert the medical data in the form of a data file into the predetermined print format, and the combination means are adapted to include in a header of the data file the data identifying the patient and the practitioner.

According to another characteristic:

the combination means are adapted to form a message in the form of a plurality of IT files comprising a common identifier;

the means for acquisition of data identifying the patient comprise means for reading the data in a patient's identification card;

the means for acquisition of data identifying the practitioner comprise means for reading the data in a practitioner's identification card;
the means for acquisition of the data identifying the practitioner further comprise means for authentication of the latter;
the authentication means comprise means for manual capture of an authentication code by the operator and comparison means for comparing the code with a code stored in the practitioner's identification card in order to authenticate at least the practitioner in dependence on the result of the comparison;
the means for acquisition of data identifying the patient and/or the practitioner comprise means for manual capture of the data;
the combination means are adapted to generate and incorporate in the message a digital signature in order to authenticate the practitioner and/or to verify, notably at the data server, the integrity of the patient's identification data and of the medical data relating to the patient which is contained in the message;
the means for acquisition of the practitioner's identification data are adapted to acquire a private key associated with the practitioner for the implementation by the combination means of an asymmetric cryptography algorithm for generating the digital signature;
the means for acquisition of the practitioner's data comprise means for reading the data in a patient's identification card, and in that the reading means are adapted to read the private key associated with the practitioner in the practitioner's identification card;

the output means comprise compression means for compressing the message; and

the output means comprise means for encrypting the message.

The present invention will be more easily understood on reading the following description, provided solely by way of example, and in relation to the appended drawings, in which:

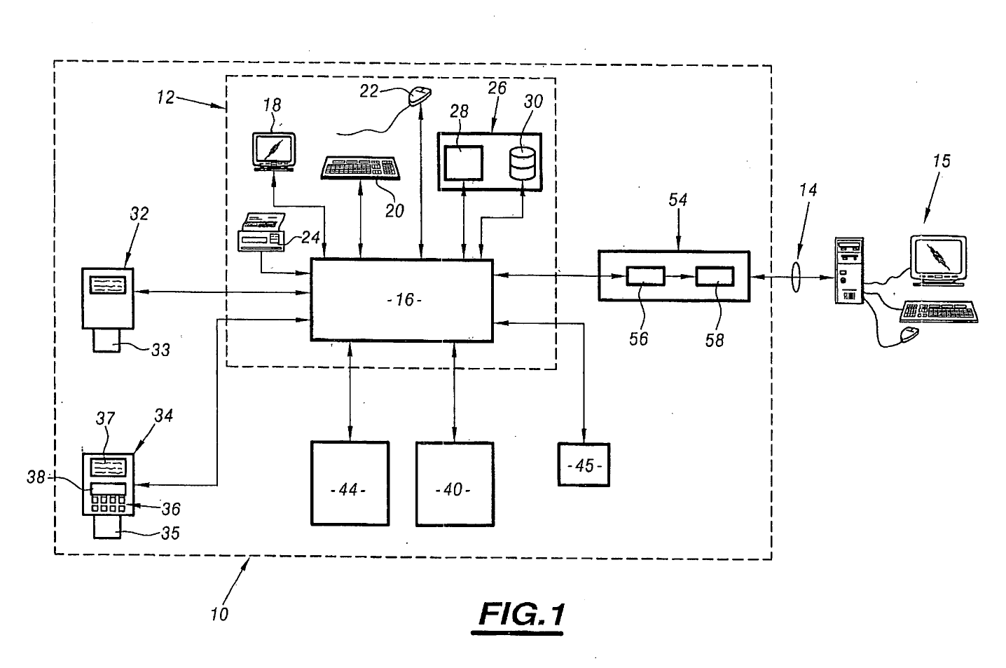

FIG. 1 is a diagrammatic view of the system according to the invention;

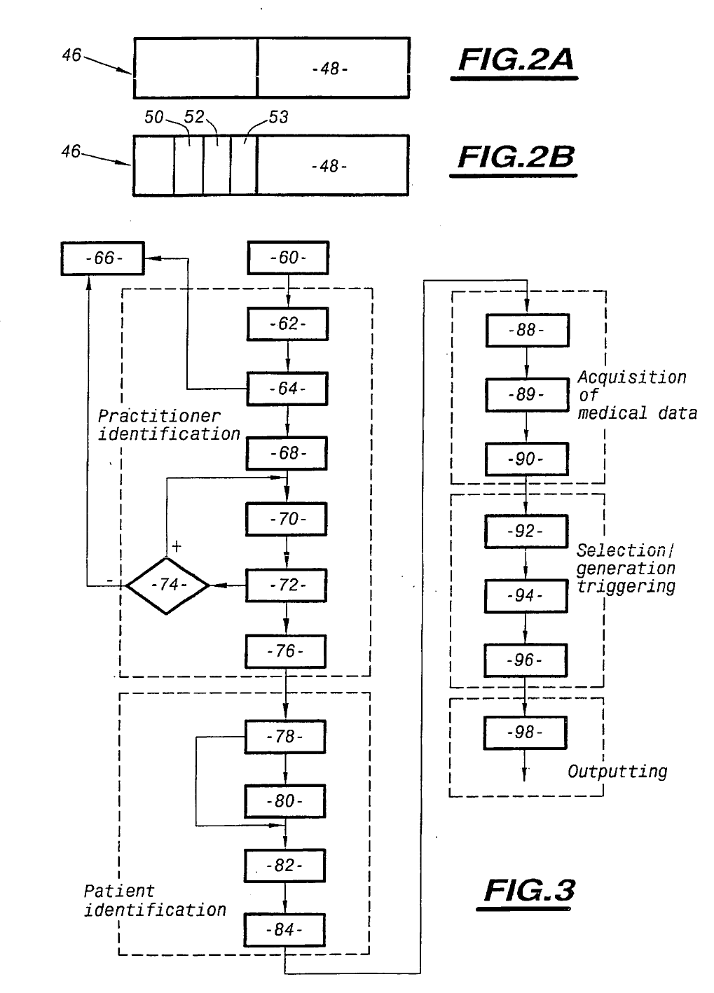

FIG. 2A is a diagrammatic view of a medical data file in the “PostScript” format;

FIG. 2B is a diagrammatic view of a message generated by the system of FIG. 1 from the file of FIG. 2A;

FIG. 3 is a flow chart of the operation of the system of FIG. 1; and

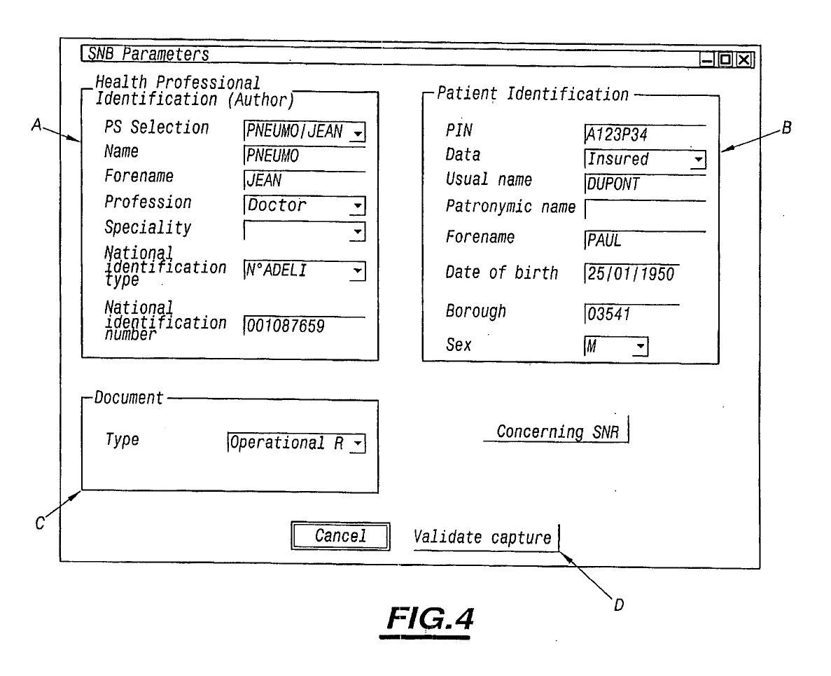

FIG. 4 is a dialogue window generated by the system of FIG. 1.

FIG. 1 illustrates diagrammatically a system 10 for automatically generating a medical data message relating to a patient.

More particularly, a system 10 for generating a message is illustrated which comprises a generating station 12 made available to a medical operator and connected via a data transmission network 14 to at least one data server 15 for managing and storing in a centralised manner an assembly of medical data relating, notably, to the patient.

The generating station 12 is for example implemented by a data processing unit of the office computer type, installed at the site of the medical procedure performed on the patient.

The generating station 12 comprises central management means 16 connected to a predetermined assembly of peripherals for its communication with the medical operator, that is to say, the practitioner himself or any person authorised to operate the generating system 10. For example, the assembly of peripherals is constituted notably by a display screen 18, a keyboard 20 for manual data capture, pointing means 22 for pointing on the screen 18 and a printer 24. The generating station 12 further comprises data storage means 26, such as a random access memory 28 and mass storage means 30, for storing locally, either permanently or not, medical data relating to the patient as will be explained in more detail hereinafter.

The generating system 10 is adapted to acquire a predetermined assembly of data relating to the practitioner, to the patient and to the medical procedure.

More particularly, the generating system 10 comprises acquisition means 32 for acquisition of data identifying the patient. The acquisition means 32 are adapted to acquire personal data on the patient, necessary for his unambiguous identification, such as, for example, his name, social insurance number, address or other data.

Advantageously, the acquisition means 32 comprise a card reader for reading a patient's identification data contained in a health insurance card 33 inserted therein, such as for example a chip card of the “Vitale” card type attributed to the patient by his health insurance organisation. The card is inserted into the reader of the acquisition means 32 and the data contained in the card is read by the reader and delivered to the central management means 16 which stores it in the data storage means 26.

The acquisition means 32 for acquisition of the patient's identification data are moreover completed by the keyboard 20 for manual capture of data, for example for their modification and/or the manual capture by the medical operator of complementary data not contained in the card and/or the manual capture of data identifying the patient when the latter has for example forgotten his health insurance card.

The generating system 10 further comprises acquisition means 34 for acquisition of data identifying the practitioner performing the medical procedure, such as, for example, his name, his specialty, his national health professional identification number or other data, this identification data also enabling him to be identified unambiguously.

Advantageously, the acquisition means 34 also comprise a card reader adapted to read data identifying the practitioner, contained in a card 35 of the health professional chip card type, also termed “HPC” card, inserted in the reader.

The means 34 for acquisition of the data identifying the practitioner further comprise means for authentication of the latter. Indeed, the medical data message relating to the patient, generated by the generating system 10, is intended to be stored on the central server 15, for example for subsequent use by other practitioners or by an administrative body, so that it is necessary for the data to be authenticated with certainty.

In a conventional manner, the health professional card 35 contains an authentication code known only to the medical practitioner. Advantageously, the authentication means are then contained in the health professional card reader. For this purpose, the reader contains means 36 for manual capture of the code, such as a keyboard for example, and a screen 37 adapted to display a request for capture of the code and a message of validation or not of the code capture.

The code captured manually is then delivered to comparison means 38 arranged in the reader and adapted to compare the captured code with the authentication code contained in the card. In the case of correspondence between the captured code and the code contained in the card, the authentication of the practitioner is then validated and the data identifying the practitioner, contained in the card, is read and sent to the central management means 16, which stores it in the data storage means 26 for subsequent use.

Moreover, the means 34 for acquisition of the practitioner's identification data are completed by the keyboard 20, for example, for the manual capture, by the medical operator, of complementary data not contained in the health professional card.

It will be noted that other embodiments of these acquisition means may be envisaged. Thus, for example, the means 32 for acquisition of the patient's identification data and the means 34 for acquisition of the practitioner's identification data may be formed by the same acquisition means, advantageously a single card reader, which means are then used successively for reading the patient's health insurance card and the practitioner's health professional card.

The generating system 10 further comprises means 40 for acquisition of medical data. The acquisition means 40 are adapted to acquire medical data generated during the medical procedure, for example by an X-ray, an ultra-sound scan, etc . . .

The means 40 for acquisition of medical data are moreover completed by the manual data capture keyboard 20 for manual capture by the medical operator of a prescription, a medical diagnosis, etc.

The medical data acquired by the acquisition means 40 or captured manually by the keyboard 20 is then delivered to the central management means 16 for its storage in the data storage means 26 for subsequent use.

It will be understood that the medical data acquired may originate from the concatenation of several items of medical data of different types, for example acquired in succession by the system 10, automatically or manually, on the order of the medical operator.

For example, the medical data may comprise a consultation report captured by the medical operator via the keyboard 20 and an X-ray acquired as a result of an X-ray being taken of the patient.

Advantageously, the medical data acquired by the acquisition means 40 and/or the keyboard 20 also comprises data identifying the type of medical data relating to the patient, for example a predetermined code making it possible to determine unambiguously the type thereof. This makes it possible in particular to facilitate the processing, storage and classification of the medical data in the data server 15.

The data identifying the type of medical data is acquired for example by the medical operator by means of the keyboard 20 and/or the pointing means 22 in association with an appropriate dialogue window displayed on the screen 18, as will be explained in more detail hereinafter. The data is then stored in the storage means 26 for subsequent use.

As a variant, the data identifying the type of medical data also comprises additional descriptive data, such as for example one or more items of data demanded by the health organisation. This descriptive data comprises, for example, the time and date of production of the medical data.

It is generated automatically, for example, by the system 10 at the time of acquisition of the medical data or of its transmission to the server 15, or it is captured totally or in part by the medical operator by means of the keyboard 20.

In another embodiment, the data identifying the type of medical data is concatenated to the medical data stored in the storage means 26.

Combination means 44 for combining data are moreover connected to the central management means 16 and are suitable for combining the data identifying the patient, the practitioner and the type of medical data, with the medical data relating to the patient, in order to form a message according to a predetermined format for transmission on the network, in a manner which will be explained in more detail hereinafter.

Preferably, the transmission format is also a predetermined print format. Advantageously, a print format widely used and associated with display and processing software currently employed, such as, for example, a standardised format of the “PostScript” (PS) type, “Portable Document Format” (PDF) type, or other types, may be envisaged.

In order to obtain IT files in the predetermined print format, the central management means 16 are connected to conversion means 45 adapted to convert the medical data, stored in the data storage means 26, into a file in the predetermined print format, preferably in the “PostScript” format, which permits simplified processing of the files in this format, as will be explained in more detail hereinafter.

The combination means 44 are then adapted to include in a header of the data file corresponding to the medical data, the data identifying the patient and the practitioner in order to generate the medical data message, as is Illustrated in FIGS. 2A and 2B.

FIG. 2A is a diagrammatic view of a medical data file in the “PostScript” format. This file comprises a header 46 constituted by an assembly of parameters permitting its identification, its display, printing, processing, etc., and a data zone 48, as is known per se in the state of the art. For example, the data zone 48 contains the medical data, such as an X-ray.

FIG. 2B is a diagrammatic view of the medical data message generated by the combination means 44 from the above-mentioned file. Into the header of this file, the means 44 have introduced a data zone 50 comprising the data identifying the patient, a data zone 52 comprising the data identifying the practitioner, and a data zone 53 comprising the data identifying the type of medical data relating to the patient.

Other formats are possible for the message.

As a variant, the combination means 44 generate a plurality of files for the data stored in the storage means 26, for example one file per type of data. The means 44 then generate the message in the form of an archive comprising the IT files generated, the server 15 comprising the IT tools necessary for extracting the different files from this archive.

Referring again to FIG. 1, the generation of the medical data message is activated when the medical operator actuates generation triggering means, for example constituted by the pointing means 22 in association with a dialogue window displayed on the screen 18, as will also be explained in more detail hereinafter.

Finally, the generating system 10 comprises output means 54 for outputting the medical data message on the network 14. The output means 54 advantageously comprise compression means 56 for compressing the message and thus reducing the size of the data transmitted on the network 14.

The output means 54 may also comprise means 58 for encrypting the message in order to guarantee the confidentiality and security of the medical data transmitted on the data transmission network 14.

The operation of the generating system 10 will now be described in relation to the flow chart of FIG. 3.

The first step of operation of the generating system 10 is an initialisation step 60, triggered for example when the system is switched on, or for each medical procedure. The initialisation comprises in particular the selection of a predetermined degree of security. This selection determines the identification data read on the cards of the practitioner and/or of the patient, and capable of being modified by the medical operator.

Once initialisation is completed, the central management means 16, in a step 62, outputs a request for identification/authentication of the practitioner. For example, the central management means 16 commands the display of an appropriate dialogue window on the display screen 18, inviting the insertion of the practitioner's health professional card into the card reader of the acquisition means 34.

If the practitioner does not have his health professional card available, he then indicates this, in a step 64, to the central management means 16, for example by pointing to and validating by means of the pointing means 22 a button specially provided for this purpose on the above-mentioned dialogue window.

In response, in a step 66, the generating system 10 is then configured to function in a predetermined reduced mode of operation in which, at least, it cannot generate and therefore output, to the destination of the server 15, a medical data message in the predetermined transmission format.

If the practitioner has his health professional card available, he introduces it, in a step 68, into the reader of the means 34 for acquisition of the practitioner's identification data.

In response to the introduction of the card, in a step 70, a request for capture of an authentication code is then displayed on the screen 37 of the card reader 34 and the practitioner captures an authentication code by means of the capture keyboard 36 of the card reader 34.

The code captured is then delivered, in a step 72, to the comparison means 38 which compare the captured code with the authentication code contained in the card inserted into the reader. If the two codes are different, the comparison means 36, in a step 74, test whether the number of code capture attempts performed by the practitioner is greater than or equal to a predetermined number of attempts stored in the comparison means 36.

If the result of this test is positive, an error message is generated and the step 66 of configuration of the operation of the generating system is then triggered. If the result of this test is negative, the step 74 then loops onto step 70.

If the code captured by the practitioner corresponds to the authentication code contained in the card, the card reader of the means 34 for acquisition of the practitioner's identification data, in a step 76, delivers the practitioner's identification data contained in the card to the central management means, which, in response, stores the data in the data storage means 26.

In 76, the central management means 16 also commands the display, on the screen 18, of a dialogue window inviting the medical operator to capture, optionally or not, in specific fields of the window, by means of the keyboard 20, data identifying the practitioner that is complementary to that contained in the health professional card.

The complementary identification data which may have been captured is then concatenated to that stored in the storage means 26.

The operation of the generating system 10 then consists in acquiring the patient's identification data. For this purpose, in a step 78, the central management means 16 outputs a request inviting the medical operator to introduce the patient's health insurance card into the card reader of the means 32 for acquisition of the patient's identification data, for example by commanding the display of an appropriate dialogue window on the screen 18.

Following the introduction of the patient's health insurance card, in a step 80, the card reader of the means 32 for acquisition of the patient's identification data reads the data contained in the card and delivers it to the central management means 16 which then stores it in the data storage means 26.

In a step 82 of manual capture of the patient's identification data, the central management means 16 commands the display, on the screen 18, of a dialogue window inviting the medical operator to capture, optionally or not, in specific fields of the window and by means of the keyboard 20, data identifying the patient which is complementary to that contained in the health insurance card.

If the health insurance card cannot be introduced into the reader, for example as a result of being forgotten by the patient, the step 78 of requesting the introduction of the patient's card then loops onto the manual capture step 82 for the manual capture, by the medical operator, of the whole of the patient's identification data.

The patient's identification data read and/or captured is delivered in step 84 to the central management means 16 which stores it in the data storage means 26.

The following step of operation of the generating system 10 is a step 88 of acquisition of the medical data relating to the patient. During this step 88, the means 40 for acquisition of medical data, and/or the medical operator by means, for example, of the keyboard 20, acquire medical data produced at the time of the medical procedure, for example a consultation, an X-ray, a report on a surgical intervention, or other data. The data is then delivered to the central management means 16 which stores it in the data storage means 26.

A following step 89 is a step of acquisition of the data identifying the type of data relating to the patient. The central management means 16, for this purpose, commands the display of an appropriate dialogue window inviting the medical operator to capture in a specific field thereof the type of medical data or to select the latter from a predetermined list of types of medical data arranged, for example, in the form of a scrolling menu.

The data identifying the type of medical data is then delivered to the central management means 16 which stores it in response in the data storage means 26.

The conversion means 45 then, in a step 90, converts the stored medical data into one or more data files, according to requirements, in the “PostScript” print format for example.

The following step is a step 92 of selection, in the data storage means 26, by the medical operator, of the medical data relating to the patient which is to be outputted for the attention of the server 15, that is to say, the selection of one or more data files in the “Postscript” format for example. Advantageously, this selection is made by means of software for displaying, on the screen 18, documents in the predetermined format which makes it possible to run through the data storage means 26, to select a particular file and to display it.

In this selection step 92, the medical operator may trigger additional data processing to produce a single data file in the “PostScript” format, for example from a plurality of stored data files.

Once the selection of the medical data and any processing are completed, a following step 94 consists of the triggering, by the medical operator, of the formation of the medical data message which is to be outputted, for example by pressing with the pointing means 22, a button specially provided for this purpose on the dialogue window of the display software, or a button already present on the window and associated with this additional triggering function, such as for example the button actuating printing by a printer of the data displayed on the screen.

In a following step 96, the central management means 16 reads in the storage means 26 the data identifying the practitioner, the patient and the type of medical data which it delivers to the combination means 44, with the data file corresponding to the medical data selected to be transmitted to the server 15.

The combination means 44 then generate a medical data message, including in a header of the file in the “PostScript” format for example, the data identifying the practitioner, the patient and the type of medical data, as has been explained with regard to FIGS. 2A and 2B, then store the file in the storage means 26, for example for the requirements of local management of the medical data.

In a step 98, the message thus generated is then delivered to the output means 54 which compresses, encrypts and outputs it on the data transmission network 14 for the attention of the medical data server 15.

The messages are then received, sorted and stored in the server in order to be accessible with a view to subsequent use.

An example of a dialogue window recapitulating the various data acquired has been illustrated on page 4.

Advantageously, the dialogue windows for acquisition of the data identifying the practitioner, the patient and the type of medical data relating to the patient are in fact a single window of the type in FIG. 4. The window is generated by the central management means 16 and displayed on the screen 18 and its different functionalities, fields, buttons, slots, etc., are accessible in a conventional manner by means of the pointing means 22 and the capture keyboard 20.

The dialogue window comprises a plurality of groups of data fields. A first group A of fields entitled “Health Professional Identification (Author)” comprises fields relating to the data identifying the practitioner performing the medical procedure. A first field “PS Selection” is dedicated to the selection of a practitioner. In fact, the generating system 10, for example installed in a hospital, is capable of being used for generating and transmitting medical data concerning medical procedures performed by a plurality of practitioners having been authenticated and identified by the system 10. The medical operator can then select, by means of a scrolling menu associated with the field, identification data associated with a particular practitioner, in this example referenced in the system 10 by the label “PNEUMO/JEAN” from among a predetermined assembly of data identifying practitioners.

The fields “Name”, “Forename”, “Profession”, “Specialty”, “National identification type” and “National identification number” display the identification data read from the health professional card of the practitioner selected. In the example illustrated in FIG. 4, the data is not capable of being modified by virtue of the degree of security selected on initialisation of the generating system 10.

A second group B of data fields entitled “Patient Identification” lists the patient's identification data. As illustrated in FIG. 4, data displayed in the fields “PIN” or Patient Identification Number, “Data”, “Usual Name”, “Patronymic name”, “Forename”, “Date of Birth”, “Sex”, which are read on the patient's health insurance card, may be modified by the medical operator. Other fields, for example the “Borough” field, display data identifying the patient which is not capable of being modified by the medical operator.

A third group C of fields, entitled “Document”, makes it possible to select the type of medical data relating to the patient which is to be sent to the server 15. This selection is carried out by the medical operator by means of a “Type” field associated with a scrolling menu giving the predetermined list of types of medical data, the type “Operational R”, for “Operational Report”, being selected in the example illustrated in FIG. 4.

A button D “Validate capture” makes it possible, on activation by the medical operator, to validate the data displayed in the above-mentioned fields.

In a preferred embodiment of the invention, the functions described above are managed by the medical operator by means of a graphic interface of software of the virtual printer pilot type executed on the generating station 22. For example, the generation of the medical data message is triggered by the activation by the medical operator of a “print” button on a graphic window associated with a virtual printer.

It will be noted that the network 14 may be formed by any appropriate network.

According to other characteristics of the system according to the invention, the combination means 44 are further adapted to generate, and incorporate in the message to be sent to the data server 15, a digital signature from the data identifying the patient, the practitioner, the type of medical data, and the medical data relating to the patient. Such a digital signature makes it possible to authenticate the practitioner, especially at the server 15, with a greater degree of certainty. Such a signature also allows the data server 15 to verify the integrity of the data received, and particularly of the data identifying the patient and the medical data relating to the latter which is contained in the message.

In a conventional manner, the practitioner's health professional card comprises a private key associated for example solely with the practitioner. The health professional card also comprises an IT code coding an asymmetric cryptography algorithm for generating digital signatures.

The card reader of the means 34 for acquisition of data identifying the practitioner is then further adapted to read from the health professional card this key and the IT code, for example following the operation of authenticating the practitioner by the capture of his authentication code described in relation to the flow chart of FIG. 2.

The key and the IT code are then delivered to the combination means 44. The latter, for example in an additional step 97 following the step 96 and prior to the step 98 of the flow chart of FIG. 2, execute the IT code in order to generate the digital signature in dependence on the different identification data and medical data, in a manner which is known per se in the state of the art. This signature is then incorporated by the combination means 44 in the message already generated in step 96, in order to obtain the message that is finally to be sent to the server 15.

The server 15, in which is stored a public key complementary to the private key associated with the practitioner, is then in a position to process the digital signature contained in the message which it receives in order to authenticate the origin thereof and/or the integrity of the data which it contains.

It is of course also possible to envisage that the private key and the IT code coding the algorithm are stored in the generating system 10 and not in the health professional card.

Similarly, the only data identifying the practitioner which is contained in the message may consist only of the digital signature, then the message in the “PostScript” format generated in step 96 does not comprise in its header, the data zones 52 relating to the practitioner's identification data as described in relation to FIG. 2B.

Other embodiments are of course possible. For example, the scheduling of the tasks implemented by the generating system as described with reference to the above-mentioned flow chart may be modified in dependence on diverse administrative tasks carried out by the medical operator, such as, for example, the modification and/or the complementation of the data read on the cards of the practitioner and the patient following the triggering of the generation of the message.

Similarly, an authentication may be required for each outputting of a message on the network.

An embodiment of the invention has been described in which the combination means 44 form a message in the form of a single file, for example of the “post script” type, archives, etc.

As a variant, the means 44 are suitable for generating a plurality of files from the various data acquired and stored in the storage means 26 and for incorporating a common identifier in these files. For example, the combination means 44 create IT files bearing the same name but having different extensions, or each file comprises a header with the common identifier.

The message is then constituted by a plurality of IT files identifiable by the server 15 as belonging to the same assembly of data. The message may also comprise a digital signature, generated in a manner identical to that described previously, which the combination means 44 put into the form of a file comprising the common identifier.

Each of these files may also be previously compressed by the compression means 56 before its outputting on the network 14.

1-17. (canceled)

18. A system (10) for automatically generating a medical data message relating to a patient, by means of a generating station (12) made available to a medical operator and connected to a data server (15) via a data transmission network (14), wherein it comprises:
means (16, 18, 20, 22) that can be activated by the operator in the medical field to trigger the generation of the message;
means (32, 22) for acquisition of data identifying a practitioner;
means (34, 22) for acquisition of data identifying the patient;
means (40,22) for acquisition of medical data relating to the patient;
combination means (44) for combining the various data to form a message according to a predetermined format for transmission on the network; and
output means (46) for outputting the message on the network to the destination of the server.

19. A system according to claim 18, wherein the combination means (44) are adapted to form a message in the form of a single file comprising the whole of said data.

20. A system according to claim 19, wherein the predetermined transmission format of the message is also a predetermined print format.

21. A system according to claim 20, wherein the predetermined print format is a “PostScript” format.

22. A system according to claim 20, wherein the print format is a “Portable Document Format” format.

23. A system according to claim 20, wherein it comprises conversion means (45) adapted to convert the medical data in the form of a data file into the predetermined print format, and wherein the combination means (44) are adapted to include in a header of the data file the data identifying the patient and the practitioner.

24. A system according to claim 18, wherein the combination means (44) are adapted to form a message in the form of a plurality of IT files comprising a common identifier.

25. A system according to claim 18, wherein the means (32, 20) for acquisition of data identifying the patient comprise means (34) for reading the data in a patient's identification card.

26. A system according to claim 18, wherein the means (34, 20) for acquisition of data identifying the practitioner comprise means (34) for reading the data in a practitioner's identification card.

27. A system according to claim 26, wherein the means (34, 20) for acquisition of the data identifying the practitioner further comprise means (36, 38) for authenticating the latter.

28. A system according to claim 27, wherein the authentication means (36, 38) comprise means (36) for manual capture of an authentication code by the operator and comparison means (38) for comparing the code with a code stored in the practitioner's identification card in order to authenticate at least the practitioner in dependence on the result of the comparison.

29. A system according to claim 18, wherein the means for acquisition of data identifying the patient and/or the practitioner comprise means (20) for manual capture of the data.

30. A system according to claim 18, wherein the combination means (44) are adapted to generate and incorporate in the message a digital signature in order to authenticate the practitioner and/or to verify, notably at the data server (15), the integrity of the patient's identification data and medical data relating to the patient which is contained in the message.

31. A system according to claim 30, wherein the means (34, 20) for acquisition of data identifying the practitioner are adapted to acquire a private key associated with the practitioner for the implementation by the combination means (44) of an asymmetric cryptography algorithm for generating the digital signature.

32. A system according to claim 31, wherein the means (34, 20) for acquisition of the practitioner's data comprise means (34) for reading the data in a patient's identification card, and wherein the reading means (34) are adapted to read the private key associated with the practitioner in the practitioner's identification card.

33. A system according to claim 18, wherein the output means (46) comprises compression means (48) for compressing the message.

34. A system according to claim 18, wherein the output means (46) comprises means (50) for encrypting the message.
